(19) United States
(12) Patent Application Publication
(10) Pub. No.: US 2015/0199347 A1
(43) Pub. Date: Jul. 16, 2015

(54) PROMOTING DOCUMENTS BASED ON RELEVANCE

(71) Applicant: Microsoft Corporation, Redmond, WA (US)

(72) Inventors: Yauhen Shnitko, Sammamish, WA (US); Dmitriy Meyerzon, Bellevue, WA (US); Gerald Ferry, Bellevue, WA (US)

(73) Assignee: MICROSOFT CORPORATION, Redmond, WA (US)

(21) Appl. No.: 14/156,365

(22) Filed: Jan. 15, 2014

(51) Int. Cl. G06F 17/30

(52) U.S. Cl. CPC G06F 17/30011; G06F 17/3053

(57) ABSTRACT

A system for ranking documents based on activity level is provided. A document promotion system generates a view score for a document based on the number of times the document was viewed and a freshness score for the document based on when the document was last updated. The document promotion system then generates an activity score for the document based on the view score and the freshness score for the document. The activity score for a document represents the level of activity associated with the document. The document promotion system ranks documents based on their generated activity scores and provides the documents to a user in the order of the ranking.

### BACKGROUND

Many types of document management systems are available for storing documents in document repositories. These document management systems include file management systems, collaboration systems, source code management systems, video library systems, electronic mail systems, voice mail systems, and so on that store documents in a document repository. Each of these systems typically allows the documents to be stored in the document repository in a hierarchical manner and allows metadata (e.g., filename and create date) to be stored along with the content of the documents. These systems provide features that are tailored to a specific application. For example, a file management system provided by an operating system provides basic features for creating, updating, and searching for documents. A collaboration system provides features to facilitate collaborative development of documents by a team. These features may include versioning, change tracking, document check out/check in, and so on.

These document management systems allow a large number of documents to be created, changed, and viewed. It is not uncommon for a document repository to contain millions of documents. Because of the sheer number of documents, it can be difficult for a user to identify which documents need the user's attention. For example, at an organization (e.g., company), an IT worker may be a member of and provide compliance oversight for multiple projects. The IT worker may need to review design documents, requirement documents, user instruction manuals, and so on for each project to ensure that they comply with the standards of the organization. The IT worker may also need to review and edit documents that set the standards for the organization. With current document management systems, the IT worker can search for documents that need to be reviewed in various ways. For example, the IT worker can search for documents by name, but the IT worker would need to already know what documents need to be reviewed. As another example, the IT worker can search for documents by edit date to identify the documents that have been recently edited and then view the content of the documents to see what documents need attention. A difficulty with such an approach is that hundreds of documents can be edited on a given day, so the list of documents can be long. Another difficulty is that some of the edits may be minor changes (e.g., correcting a typo) made by one person and not need the IT worker's review—so the IT worker may spend time checking documents unnecessarily. Also, the IT worker may not need to review a document when it is edited, but could defer the review until the document is actually needed by a team.

### SUMMARY

A system for ranking documents based on activity level is provided. In some embodiments, a document promotion system generates a view score for a document based on the number of times the document was viewed and a freshness score for the document based on when the document was last updated. The document promotion system then generates an activity score for the document based on the view score and the freshness score for the document. The activity score for a document represents the level of activity associated with the document. The document promotion system ranks documents based on their generated activity scores and provides the documents to a user in the order of the ranking.

### BRIEF DESCRIPTION OF DRAWINGS

FIG. 1 is a block diagram that illustrates components of a document promotion system in some embodiments.

FIG. 2 is a flow diagram that illustrates the processing of an indexer component of the document promotion system in some embodiments.

FIG. 3 is a flow diagram that illustrates the processing of the search engine of the document promotion system in some embodiments.

FIG. 4 is a flow diagram that illustrates the processing of the rank documents component of the document promotion system in some embodiments.

### DETAILED DESCRIPTION

A method and system for highlighting documents for user review based on the activity level of the documents is provided. In some embodiments, a document promotion system generates an activity score for each document indicating the level of user activity associated with the document. The user activities may include creating a document, editing a document, viewing a document, printing a document, archiving a document, and so on. The document promotion system may quantify different types of user activity as sub-scores to generate an activity score indicating the activity level of each document. The document promotion system may quantify the activity of viewing a document using a view score derived from the number of times the document was viewed. The document promotion system may assume that a user may be more interested in documents that have been viewed many times than those that have been viewed only a few times. The document promotion system may quantify the activity of accessing a document using a unique user score derived from the number of unique users who have accessed the document. The document promotion system may assume that a user may be more interested in documents that have been accessed by many different users than those accessed many times but only by a few users. The document promotion system may quantify the activity of updating the document using a freshness score derived from when the document was last updated. The document promotion system may assume that a user may be more interested in newly updated (e.g., created or changed) documents than those that have not been updated for a while. The document promotion system may generate the activity score for a document based on a combination of the sub-scores. The document promotion system may then rank the documents based on their activity scores and present those documents to a user based on their ranking. In this way, the document promotion system can automatically identify documents to present to a user that are more likely to be of interest to the user.

In some embodiments, the document promotion system may generate the activity score for a document based on a weighted combination of sub-scores. For example, the document promotion system may generate sub-scores for different types of activities in the range of 0 to 1, with 0 meaning a low level of activity and 1 meaning a high level of activity. The document promotion system may weight one sub-score more than another sub-score to reflect the effect of the type of activity on user interest in a document. In addition, the document promotion system may use different weights for different users. The weights for a user may be tuned by the user. So, for example, a user interested in tracking documents that are of interest to a wide range of users may weight the unique user score highly. The document promotion system may also learn the weights for each user using various machine learning techniques based on “click-through” data indicating which documents a user selected when presented with a list of ranked documents. For example, if a user tends to select documents that have been recently updated, then a machine learning technique may generate a fairly high weight for the freshness score.

In some embodiments, the document promotion system may factor in the recency of user activity when generating a sub-score. For example, when generating a view score, the document promotion system may consider only those views within a view window (e.g., last two days, last week, and last month) or may consider all views but with their contribution to the view score decaying over time. If the contributions decay (e.g., exponentially) over time, a document with many views a week ago may have a lower view score than a document with only two views two days ago, and a document with only one view in the last day may have an even higher view score than the other documents. In a similar manner, when generating a unique user score, the document promotion system may consider only those accesses within an access window (e.g., one week), may consider all accesses but with their contribution to the unique user score decaying over time, and so on. The document promotion system may also weight the activity of certain users, referred to as distinguished users, more than the activity of other users. For example, a user who is a member of a team may be more interested in documents accessed by other members of the team than those accessed by non-members. As another example, a user may be more interested in documents accessed by the user or the user's supervisor than those accessed by subordinates. The document promotion system may also use machine learning techniques (e.g., based on gradient descent) to learn the influence of recent activity or activity by distinguished users on the sub-scores for a user.

In some embodiments, the document promotion system may generate the activity score based on the following equation:

AS_{d}=wᵥ*VS_{d}+wᵤᵤ*UUS_{d}+w_{F}*FS_{d} (1)

where AS_{d} represents the activity score of document d, VS_{d} represents the view score of document d, UUS_{d} represents the unique user score of document d, FS_{d} represents the freshness score for document d, wᵥ represents the weight of the view score, wᵤᵤ represents the weight of the unique user score, and W_{F} represents the weight of the freshness score. In some embodiments, the document promotion system may use different combinations of sub-scores to generate an activity score. For example, the document promotion system may generate an activity score based only on a view score and a unique user score or only on a view score and a freshness score.

In some embodiments, the document promotion system may generate the view score based on the following equation:

$${VS}_{d} = \frac{{cV}_{d}}{{cV}_{d} + sV} \qquad ( 2 )$$

where cV_{d} represents the number of times document d was viewed and sV represents a tunable saturation parameter. The document promotion system may generate the unique user score based on the following equation:

$${UUS}_{d} = \frac{{cUU}_{d}}{{cUU}_{d} + sUU} \qquad ( 3 )$$

where cUU_{d} represents the number of unique users who accessed document d and sUU represents a tunable saturation parameter. The document promotion system may generate the freshness score based on the following equation:

$${FS}_{d} = \frac{1}{( 1 + {cF}_{d} * sF )} \qquad ( 4 )$$

where cF_{d} represents the time since document d was last updated and sF represents a tunable saturation parameter.

In some embodiments, the document highlight system generates cV_{d}, cUU_{d}, and cF_{d} using an exponential decay function represented by the following equation:

cX_{d}Σe^{-λt} (5)

where X represents V, UU, or F, t represents the time since the access, and λ represents the rate of decay. This equation results in counting most recent accesses (e.g., t=0) as one and counting less recent accesses as rapidly approaching zero depending on the decay rate. The use of saturation parameters allows control over how rapidly a sub-score approaches 1. For example, a low saturation parameter (e.g., 1) results in a smaller influence on the sub-score with an increasing number (e.g., count of views or time since update). A high saturation parameter (e.g., 100) results in a larger influence on the sub-score with an increasing number. The document highlight system may allow a user to set these tunable parameters and decay rates or may use machine learning techniques to learn them.

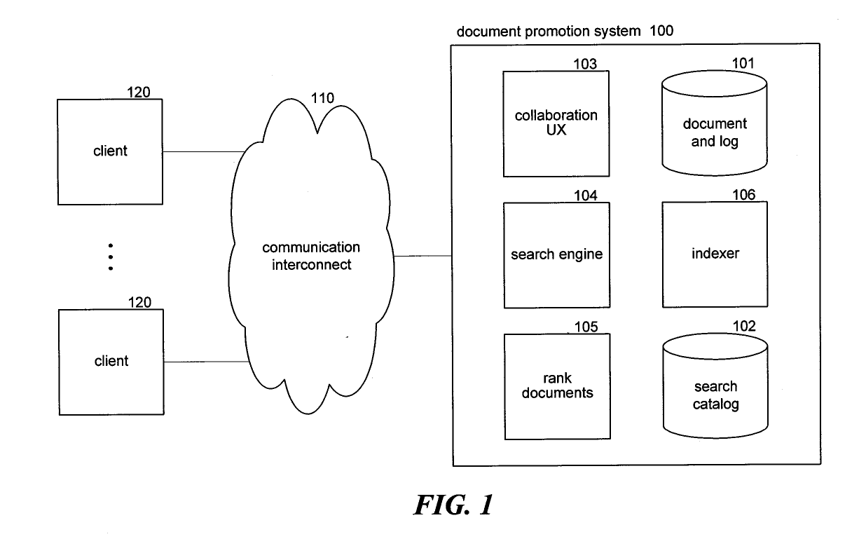

FIG. 1 is a block diagram that illustrates components of a document promotion system in some embodiments. The document promotion system 100 is described in the context of a collaboration system that communicates with client devices 120 via a communication interconnect 110. The client devices may be desktop computers, tablet computers, smart phones, and so on. The communications interconnect may be the Internet, an intranet, and so on. The document promotion system includes a document and log repository 101 and a search catalog 102. The document and log repository, which may be a distributed repository, is a shared library that contains the documents of the collaboration system along with logs indicating accesses to the documents. For example, the logs may include an indication of each access to a document along with the time of access, the identifier of the person or program that accessed the document, the type of access (e.g., create, view, and change), and so on. The search catalog may contain an index mapping words of the documents to the documents that contain those words and may also contain a summary of the logs. For example, the summary of the logs may summarize the logs into time buckets for different time periods. Each bucket may include a count of the accesses that occurred within that time period. For example, if the time period is one day, then each bucket may contain a count of the number of users who accessed each document during that day. The time periods may also be variable in length with time periods for more recent times representing shorter time periods. For example, the time periods for the last week may be a day long, the time periods for the prior three weeks may be a week long, and the time periods for the prior 11 months may be a month long.

The document promotion system may also include a collaboration user interface component 103, a search engine 104, a rank documents component 105, and an indexer component 106. The indexer component populates the search catalog based on information in the document and log repository. The collaboration user interface component may provide a conventional user interface of a collaboration system that has been modified to present documents based on activity level. The search engine may be a conventional search engine that receives a query, uses the search catalog to identify documents that match the query, and ranks the identified documents based on activity level. The rank documents component is provided a list of documents and ranks the documents based on activity level based on information in the document and log repository and/or the search catalog.

The computing devices and systems on which the document promotion system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing devices may include desktop computers, laptops, tablets, e-readers, personal digital assistants, smartphones, gaming devices, servers, and computer systems such as massively parallel systems. The computing devices may access computer-readable media that includes computer-readable storage media and data transmission media. The computer-readable storage media are tangible storage means that do not include a transitory, propagating signal. Examples of computer-readable storage media include memory such as primary memory, cache memory, and secondary memory (e.g., DVD) and include other storage means. The computer-readable storage media may have recorded upon or may be encoded with computer-executable instructions or logic that implements the document promotion system. The data transmission media is used for transmitting data via transitory, propagating signals or carrier waves (e.g., electromagnetism) via a wired or wireless connection.

The document promotion system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various embodiments. Aspects of the document promotion system may be implemented in hardware using, for example, an application-specific integrated circuit (“ASIC”).

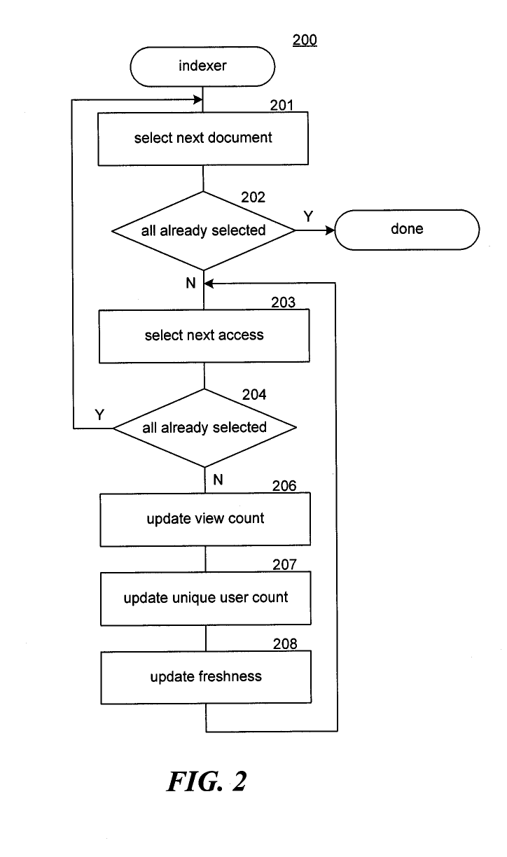

FIG. 2 is a flow diagram that illustrates the processing of an indexer component of the document promotion system in some embodiments. The indexer component may execute periodically to update the search catalog. The component may update the access counts for the most recent time period and combined counts for less recent time periods. In block 201, the component selects the next document. In decision block 202, if all the documents have already been selected, then the component completes, else the component continues at block 203. In blocks 203-208, the component loops selecting each access to the selected document. In block 203, the component selects the next access for the selected document. In decision block 204, if all the accesses have already been selected for the selected document, then the component loops to block 201 to select the next document, else the component continues at block 206. In block 206, the component updates the view count for the selected document as appropriate. In block 207, the component updates the unique user count for the selected document as appropriate. In block 208, the component updates the freshness score for the selected document if the access was an update. The component then loops to block 203 to select the next access. The illustrated processing assumes that a separate log is maintained for each document. The document promotion system may alternatively maintain a single log that lists each access to each document.

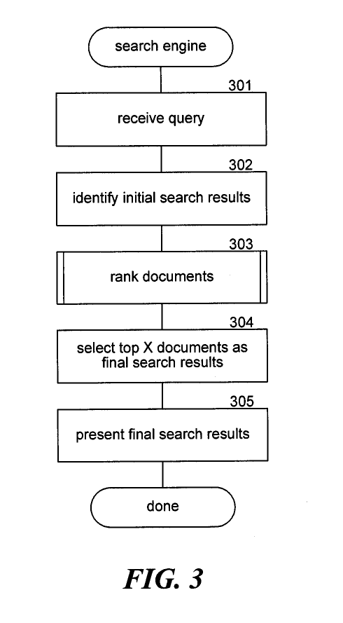

FIG. 3 is a flow diagram that illustrates the processing of the search engine of the document promotion system in some embodiments. The search engine receives a query and presents results in an order based on activity level. In block 301, the component receives or generates the query. For example, the query may specify certain metadata and certain content of the document such as being authored by a certain person and identify a site or other collection of documents. The document promotion system may automatically generate the query based on the context of an application requesting the documents. For example, if the request is made by a spreadsheet program, the query may specify to select only spreadsheet documents. In block 302, the component identifies documents that satisfy the query as initial search results. In block 303, the component invokes the rank documents component passing an indication of the initial search results to generate a ranking of the documents based on their activity level. In block 304, the component selects the top documents as the final search results of the query. In block 305, the component presents the selected documents as the final results of the query and then completes.

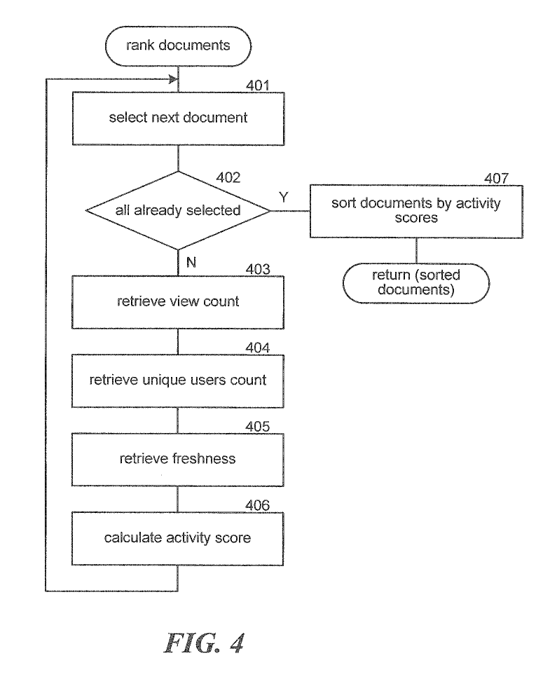

FIG. 4 is a flow diagram that illustrates the processing of the rank documents component of the document promotion system in some embodiments. The component is passed a list of documents, generates an activity score for each document, and then sorts the documents based on their activity scores. In block 401, the component selects the next document. In decision block 402, if all the documents have already been selected, then the component continues at block 407, else the component continues at block 403. In block 403, the component retrieves the view counts for the selected document. In block 404, the component retrieves the unique user counts for the selected document. In block 405, the component retrieves the freshness information for the selected document. In block 406, the component calculates an activity score according to Equation 1. The component then loops to block 401 to select the next document. In block 407, the component sorts the documents based on their activity scores and returns the sorted documents.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. For example, although the document promotion system has been described primarily in the context of views and updates to a document, the activity level may factor in many different types of user activity or even non-user activity. Other user and non-user activity may include publishing a document to a web site, archiving a document, printing a document, changing metadata associated with a document (e.g., primary author), and so on. Accordingly, the invention is not limited except as by the appended claims.

I/we claim:

1. A computer-readable memory storing computer-executable instructions for controlling a computer system to generate an activity score for a document, the computer-executable instructions comprising:
instructions that generate a view score for the document based on number of times the document was viewed;
instructions that generate a unique user score for the document based on number of users who have accessed the document; and
instructions that generate the activity score for the document based on the view score and the unique user score for the document.

2. The computer-readable memory of claim 1 further comprising instructions that generate a freshness score for the document based on when the document was last updated and wherein the instructions that generate the activity score further base the activity score on the freshness score.

3. The computer-readable memory of claim 1 wherein the view score is based on number of times the document was viewed during a view window.

4. The computer-readable memory of claim 1 wherein the instructions that generate the view score weight recent views more than less recent views.

5. The computer-readable memory of claim 1 wherein the instructions that generate the view score weight views by a distinguished user more than views by other users.

6. The computer-readable memory of claim 1 wherein the unique user score is based on number of unique users who accessed the document within an access window.

7. The computer-readable memory of claim 1 wherein the instructions that generate the unique user score weight recent accesses more than less recent accesses.

8. The computer-readable memory of claim 1 wherein the instructions that generate the unique user score weight accesses by a distinguished user more than accesses by other users.

9. The computer-readable memory of claim 1, further comprising instructions that generate activity scores for a plurality of documents and rank the documents based on their activity scores.

10. A computing system for generating activity scores for documents, the computing system comprising:
a memory storing computer-executable instructions of:
a component that generates a view score for a document based on number of times the document was viewed;
a component that generates a freshness score for a document based on when the document was last updated;
a component that generates an activity score for a document based on the view score and the freshness score for the document; and
a component that ranks documents based on their generated activity scores; and
a processor that executes the computer-executable instructions stored in the memory.

11. The computing system of claim 10 wherein the memory further stores computer-executable instructions of a component that generates a unique user score for a document based on number of users who have accessed the document and wherein the component that generates the activity score further bases the activity score on the unique user score.

12. The computing system of claim 11 wherein the unique user score is based on number of unique users who accessed a document within an access window.

13. The computing system of claim 11 wherein the component that generates the unique user score weights recent accesses more than less recent accesses.

14. The computing system of claim 10 wherein the view score is based on number of times the document was viewed during a view window.

15. The computing system of claim 10 wherein the component that generates the view score weights recent views more than less recent views.

16. The computing system of claim 10 wherein the component that generates the unique user score weights accesses by one or more distinguished users more than accesses by other users.

17. The computing system of claim 10 wherein the memory further stores computer-executable instructions of a component that generates activity scores for a plurality of documents and ranks the documents based on their activity scores.

18. A method performed by a computing system for ranking documents of a shared document library, the method comprising:
generating a search request;
identifying documents of the shared library that match the search request as initial results;
for a plurality of documents of the initial results,
generating a view score for the document based on number of times the document was viewed, such that recent views are weighted more than less recent views;
generating a unique user score for the document based on number of users who have recently accessed the document, such that recent accesses are weighted more than less recent accesses;
generating a freshness score for the document based on when the document was last updated; and
generating an activity score for the document indicating amount of recent activity based on a weighed combination of the view score, the unique user score, and the freshness score for the document; and
selecting the identified documents with activity scores indicating greatest amount of recent activity as final search results; and
presenting to the user the selected documents as final search results of the search request in an order based on their activity scores.

19. The method of claim 18 wherein the activity scores for the identified documents are generated before generating the search request.

20. The method of claim 18 wherein the activity scores for the identified documents are generated after generating the search request.
